(19) United States
(12) Patent Application Publication
(10) Pub. No.: US 2008/0049427 A1
(43) Pub. Date: Feb. 28, 2008

(54) MULTICOLORED LIGHTING FIXTURE

(76) Inventor: Young Nam OH, Bupyeong-Gu (KR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/687,747

(22) Filed: Mar. 19, 2007

(30) Foreign Application Priority Data
Aug. 22, 2006 (KR) 20-2006-0022486

(51) Int. Cl. F21V 15/01

(52) U.S. Cl. 362/267

(57) ABSTRACT

A lighting fixture has a housing, a socket provided to the center portion of the housing, a reflector attached to the inner surface of the housing, and a lamp screwed into the socket. An annular band-shaped sealing plate, a disc-shaped cover plate, and an annular band-shaped locking plate are sequentially placed on the upper end of the housing, and the locking plate is placed on the periphery of the cover plate and is locked to the housing. A groove is defined in the inner surface of the skirt portion bent from the locking plate, the sealing plate is detachably fitted into the groove, an engagement projection is formed on the inner edge of the locking plate, and the cover plate is locked to the engagement projection, whereby a space is defined between the cover plate and the sealing plate. The locking plate and the cover plate have different colors.

### BACKGROUND OF THE INVENTION

1. Field of the Invention

The present invention relates to a multicolored lighting fixture capable of emitting multicolored light and, more particularly, to a multicolored lighting fixture in which an annular band-shaped locking plate having a first color is locked to the periphery of a cover plate having a second color, a groove is defined on the inner surface of the skirt portion bent from the locking plate, and an annular band-shaped sealing plate is detachably fitted into the groove in such a way as to define a space between the sealing plate and the cover plate, so that the light emitted from a lamp can have multiple colors, thereby creating an elegant atmosphere.

2. Description of the Prior Art

In general, illumination is a technique of using a light source to benefit human life. Illumination is used to illuminate things and the surroundings, to create an atmosphere on a stage, in a restaurant, etc., to serve as information delivery means, such as traffic signals, neon signs, road information displays, etc., to sterilize, heat and dry items using ultraviolet and infrared rays, or to decoy fishes or insects and cultivate plants by targeting creatures other than human beings. Illumination is divided into natural illumination and artificial illumination depending upon the kind of light source.

Natural illumination uses light generated by the sun, stars, the moon, and creatures. Only the sun is used as an illumination source. Sunlight is called natural light and is usually introduced into an indoor space through a window.

Artificial illumination uses an artificial light source, and generally means illumination using an electric light bulb. In the age in which fire or an oil lamp was used as an artificial light source, illumination was used to see things at night. In modern times, illumination is used both at night and during the day. In most artificial light sources, since the luminosity of light is stable and constant, advantages are provided in that the precise design of illumination is possible.

Artificial illumination started when the human race developed fire. For a long time, the human race developed methods of controlling and using fire. In due course, a torchlight obtained by burning oil contained in wood, a lamp using animal or vegetable oil, and a candle using paraffin were made. Light sources that are widely used in modern times include an incandescent bulb, a discharge lamp, a fluorescent lamp, an LED lamp, etc.

In lighting fixtures using these light sources, since the light having the same color as a lamp is directed into an indoor space, even when a lamp or a cover plate is painted with a color, only a single color of light is emitted from the lighting fixture, which does not help create an elegant atmosphere.

To overcome this problem, in a conventional lighting fixture, a plurality of cover plates is provided to direct multicolored light into an indoor space to thereby create an elegant atmosphere. However, in this case, the lighting fixture encounters a drawback in that miniaturization is difficult, construction is complicated, and costs are increased due to the presence of a number of cover plates.

### SUMMARY OF THE INVENTION

Accordingly, the present invention has been made keeping in mind the above problems occurring in the prior art, and an object of the present invention is to provide a multicolored lighting fixture which has a simple construction to thus improve economic efficiency and can emit two-toned or multicolored light using one lamp, thereby creating a cultured and elegant atmosphere.

In order to achieve the above object, according to one aspect of the present invention, there is provided a lighting fixture having a housing, a socket provided in the center portion of the lower end of the housing, a reflector detachably attached to the inner surface of the housing, and a lamp screwed into the socket, wherein an annular band-shaped sealing plate, a substantially transparent disc-shaped cover plate, and an annular band-shaped locking plate are sequentially placed on the upper end of the housing, and the locking plate is placed on the periphery of the cover plate and is locked to the housing.

According to another aspect of the present invention, a groove is defined on the inner surface of the skirt portion, bent from the locking plate, the sealing plate is detachably fitted into the groove, an engagement projection is formed on the inner edge of the locking plate, and the cover plate is locked to the engagement projection of the locking plate, whereby a space is defined between the cover plate and the sealing plate.

According to still another aspect of the present invention, the colors of the locking plate and the cover plate are different from each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a multicolored lighting fixture in accordance with an embodiment of the present invention;

FIG. 2 is an assembled cross-sectional view illustrating the multicolored lighting fixture in accordance with the embodiment of the present invention;

FIG. 3 is an assembled cross-sectional view illustrating a multicolored lighting fixture in accordance with a variation of the embodiment of the present invention;

FIG. 4 is an assembled cross-sectional view illustrating a multicolored lighting fixture in accordance with another variation of the embodiment of the present invention;

FIG. 5 is a perspective view illustrating the multicolored lighting fixture in accordance with the embodiment of the present invention in a state of being used; and

FIG. 6 is a perspective view illustrating a ceiling installation version of the multicolored lighting fixture in accordance with the embodiment of the present invention in a state of being used.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

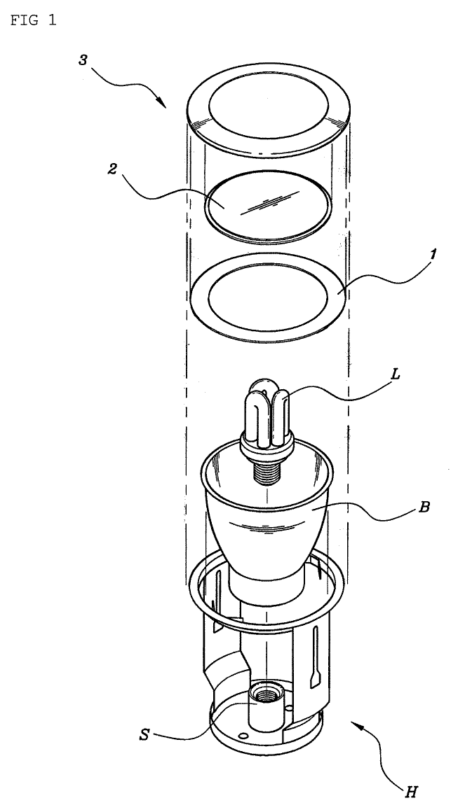

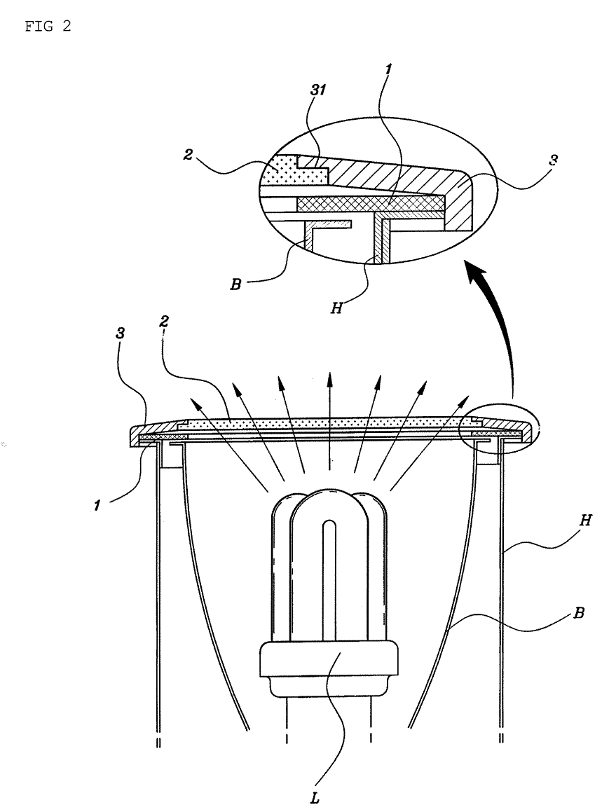

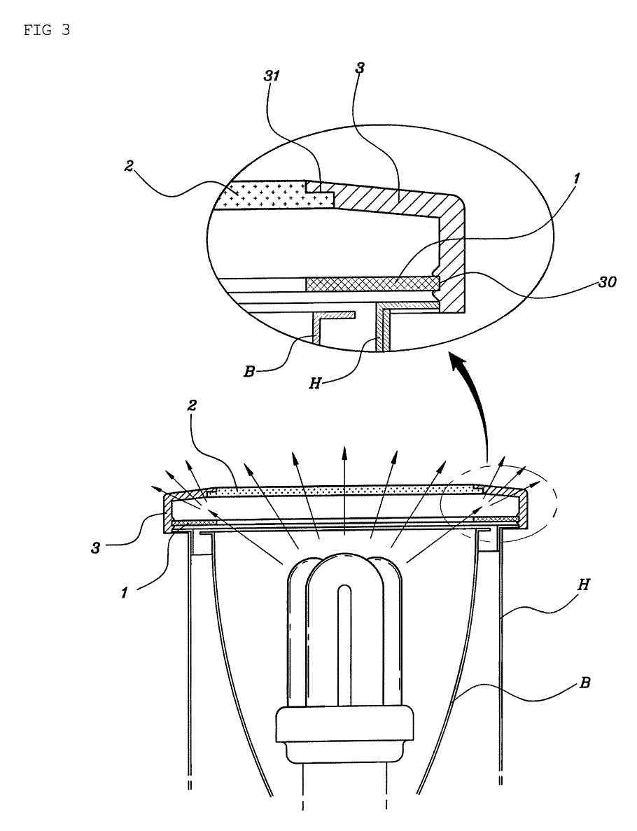

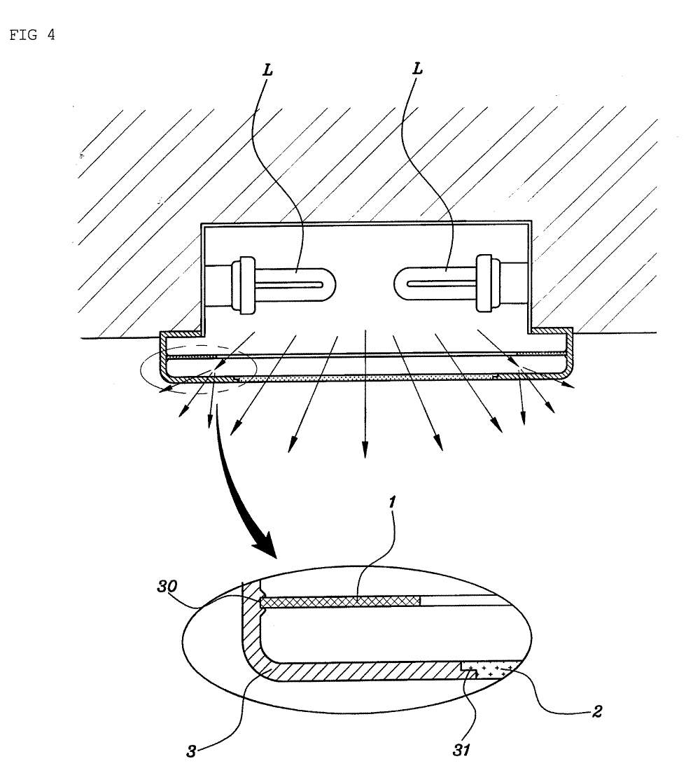

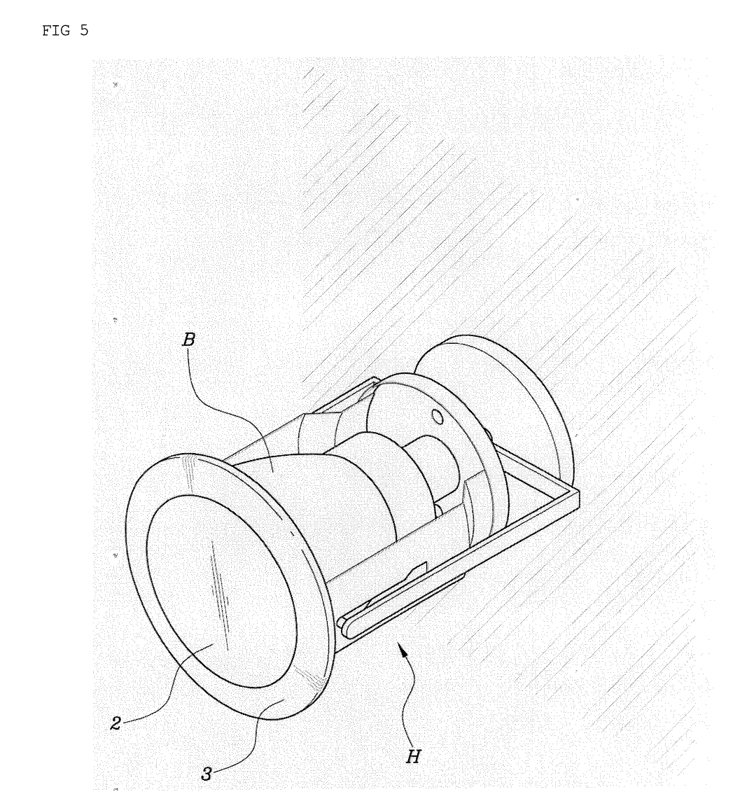

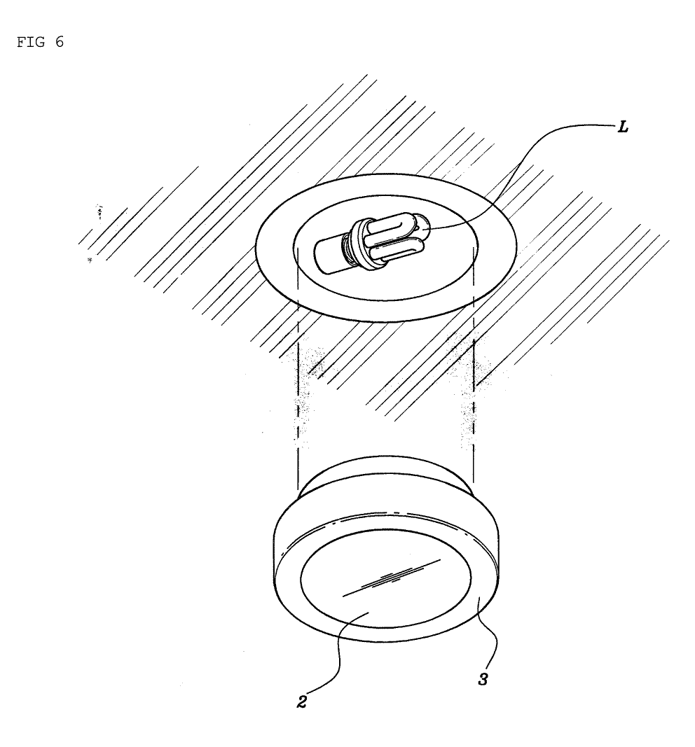

FIG. 1 is an exploded perspective view illustrating a multicolored lighting fixture in accordance with an embodiment of the present invention, FIG. 2 is an assembled cross-sectional view illustrating the multicolored lighting fixture in accordance with the embodiment of the present invention, FIG. 3 is an assembled cross-sectional view illustrating a multicolored lighting fixture in accordance with a variation of the embodiment of the present invention, FIG. 4 is an assembled cross-sectional view illustrating a multicolored lighting fixture in accordance with another variation of the embodiment of the present invention, FIG. 5 is a perspective view illustrating the multicolored lighting fixture in accordance with the embodiment of the present invention in a state of being used, and FIG. 6 is a perspective view illustrating a ceiling installation version of the multicolored lighting fixture in accordance with the embodiment of the present invention in a state of being used.

A multicolored lighting fixture according to the present invention has a housing H, a socket S provided in the center portion of the lower end of the housing H, a reflector B detachably attached to the inner surface of the housing H, and a lamp L screwed into the socket S.

The reference numeral 1 designates a sealing plate. The sealing plate 1 performs a sealing function between the housing H and a cover plate 2 and a locking plate 3 which will be described below.

The sealing plate 1 has an annular band-shaped configuration. The configuration of the sealing plate 1 can be changed in a variety of ways depending upon the configuration of the housing H. In this embodiment, an opening is defined at the center portion of the sealing plate 1, and therefore, the sealing plate 1 has the shape of a ring.

The reference numeral 2 designates a cover plate. The cover plate 2 functions to direct the light emitted from the lamp L to the outside, that is, into an indoor space. The cover plate 2 may be transparent or translucent but is not limited thereto.

That is to say, the cover plate 2 may have any desired color. While the cover plate 2 has a disc-shaped configuration in this embodiment, the configuration of the cover plate 2 can be changed in a variety of ways depending upon the configuration of the housing H.

The reference numeral 3 designates a locking plate. The locking plate 3 is placed on the periphery of the cover plate 2 and is locked to the housing H. The configuration of the locking plate 3 can also be changed in a variety of ways depending upon the configuration of the housing H. In this embodiment, the locking plate 3 has an annular band-shaped configuration.

Preferably, a groove 30 is defined on the inner surface of the skirt portion bent from the annular band-shaped locking plate 3, the sealing plate 1 is detachably fitted into the groove 30, an engagement projection 31 is formed on the inner edge of the locking plate 3, and the cover plate 2 is locked to the engagement projection 31 of the locking plate 3, so that a space 4 is defined between the cover plate 2 and the sealing plate 1.

Preferably, the annular band-shaped locking plate 3 and the disc-shaped cover plate 2 are different colors.

In the construction as described above, due to the fact that the cover plate 2 and the locking plate 3 placed on the periphery of the cover plate 2 are different colors and are spaced apart from the sealing plate 1 to thus be separated from the lamp L by a predetermined distance, thereby defining the space 4, when the light emitted from the lamp L is reflected by the reflector B and passes through the cover plate 2, the color of part of the light is determined by the color of the cover plate 2. Also, as the remainder of the light passes through the locking plate 3 due to the presence of the space 4, the remainder of the light, having passed through the locking plate 3, has a color which is different from the part of the light that passed through the cover plate 2. In this way, it is possible to create a two-toned refined and elegant indoor atmosphere. As a consequence, diverse atmospheres can be created at a reduced cost and using a simple structure by replacing the locking plate 3 and the cover plate 2 as desired.

As is apparent from the above description, the multicolored lighting fixture according to the present invention provides advantages in that, since a space is defined between a cover plate and a sealing plate, the sealing plate is naturally spaced apart from the locking plate locked to the periphery of the cover plate, and therefore, the light emitted from a lamp can have two-toned or multiple colors due to the presence of the locking plate, which is a first color, and the cover plate, which is a second color, whereby it is possible to create an antique and elegant indoor atmosphere.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A lighting fixture having a housing, a socket provided to a center portion of a lower end of the housing, a reflector detachably attached to an inner surface of the housing, and a lamp screwed into the socket, wherein an annular band-shaped sealing plate, a substantially transparent disc-shaped cover plate, and an annular band-shaped locking plate are sequentially placed on an upper end of the housing, and the locking plate is placed on a periphery of the cover plate and is locked to the housing.

2. The lighting fixture as set forth in claim 1, wherein a groove is defined on an inner surface of a skirt portion bent from the locking plate, the sealing plate is detachably fitted into the groove, an engagement projection is formed on an inner edge of the locking plate, and the cover plate is locked to the engagement projection of the locking plate, whereby a space is defined between the cover plate and the sealing plate.

3. The lighting fixture as set forth in claim 1, wherein colors of the locking plate and the cover plate are different from each other.
